(19) United States
(12) Patent Application Publication
(10) Pub. No.: US 2009/0033690 A1
(43) Pub. Date: Feb. 5, 2009

(54) INK JET DEVICE AND METHOD FOR RELEASING A PLURALITY OF SUBSTANCES ONTO A SUBSTRATE

(75) Inventors: Anke Pierik, Eindhoven (NL); Johan Frederik Dijksman, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/160,222

(22) PCT Filed: Jan. 11, 2007
(86) PCT No.: PCT/IB2007/050087

§ 371 Date: Jul. 8, 2008

(30) Foreign Application Priority Data
Jan. 12, 2006 (EP) 06100283.8

(51) Int. Cl. B41J 3/00; B41J 2/145

(52) U.S. Cl. 347/2; 347/40

(57) ABSTRACT

The invention provides an ink jet device for releasing a plurality of substances onto a substrate, the device comprising at least one print head, which is positionable relative to the substrate, and which comprises at least one nozzle, provided to eject a droplet. The ink jet device is designed such that the plurality of substances can be deposited onto the substrate in a predefined pattern in a limited amount of moves of the at least one print head relative to the substrate.

The present invention relates to an ink jet device and a method for releasing a plurality of substances onto a substrate.

The present invention discloses an ink jet device and a method for releasing a plurality of substances onto a substrate. Especially for diagnostics, substrates are needed where a plurality of different substances are positioned according to a specific predefined pattern in a very precise and accurate manner. This plurality of substances are usually deposited onto a substrate in order to perform a multitude of biochemical tests or reactions on the substrate. To be able to perform the tests or reactions in a reliable and reproducible manner it is important to provide an ink jet device and printing method with a high degree of precision. The ink jet device and the method according to the present invention are therefore preferably applied to the printing process of substances onto a substrate, where the printing process has to be extremely reliable regarding the question whether a droplet of the substance has been correctly positioned on the substrate according to the predefined pattern. Furthermore, the ink jet device and the method according to the present invention are preferably used for producing a biological assay substrate by releasing a plurality of substances onto the substrate in a specific pattern.

A method for producing a biological assay substrate by releasing a plurality of substances onto a substrate in a specific pattern is for instance disclosed in US Patent Application US 2005/0221279 A1. Herein a method is described of producing a chemical sensor that includes providing an optical array and contact printing one or more indicator chemistries to the optical array using one or more rigid pin printing tools. The method provides a means of precisely printing many different materials in a given pattern and a wide variety of microdot geometries.

Although the known ink jet device and method are able to print substances onto a substrate in a satisfactory manner, their production speed is relatively low. This strongly limits the applicability of the printing or ink jet device especially for applications where a reliable and automated printing process using a plurality of different substances is essential for an economical production of the biological assay substrates. Indeed, particularly for biological assay substrates it is important to be able to produce a plurality of substrates in as short a production time as possible, without however sacrificing reliability and accuracy of the printing process. Furthermore, flexibility with respect to the specific print patterns achievable (pitch between dots, number of fluids) is very advantageous regarding production time.

It is therefore an object of the present invention to provide an ink jet device and a method for releasing a plurality of substances onto a substrate with an increased production speed and a high degree of reliability while handling a plurality of different printing fluids or substances to print.

The above object is accomplished by an ink jet device and method for releasing a plurality of substances onto a substrate, and by the use of an ink jet device according to the present invention. The ink jet device thereto comprises at least one print head, which is positionable relative to the substrate, and which comprises at least one nozzle, provided to eject a droplet of one of the substances, whereby the ink jet device is designed such that the plurality of substances can be deposited onto the substrate in a predefined pattern in about one move of the at least one print head relative to the substrate. By these measures it now becomes possible to produce a high number of substrates, each provided with a high number of different substances in a relatively short amount of time and moreover with the desired level of reliability and accuracy.

According to the invention the ink jet device allows to produce the substrate in a limited amount of moves of the print head or print heads relative to the substrate. By this is meant that the ink jet device is able to deposit many substances simultaneously during a passage of the print head(s) over the substrate. The amount of moves obviously depends on the specifics of the substrate, but preferably should be lower than ten, more preferably lower than 5, and most preferably about one. Preferably such moves or passages are about continuous, by which is meant that the moves occur basically in one direction only without substantially deviating from this direction. This direction is hereunder also referred to as the printing direction. According to this preferred embodiment, the ink jet device is for instance able to produce fully continuous as well as consecutive start-stop movements in the printing direction.

According to the invention the ink jet device comprises at least one nozzle, provided to eject a droplet of one of the substances. The at least one print head of the ink jet device is thereto provided with a transducer. The transducer is a—preferably electromechanical—transducer applying mechanical and hydro-acoustical waves into the print head. The at least one print head is preferably an almost closed volume at least partially filled with the liquid to be printed, i.e. the substance to be printed. The print head is provided with filling means that at least comprise a reservoir containing the substance to be printed, and preferably also comprises means to hold the print head under a slight vacuum pressure. A connection line to the reservoir allows sucking in substance from the reservoir to the print head. The print head is further provided with an opening or a duct where upon an actuation pulse at least a part of the liquid contained in the print head can be expelled or ejected forming outside of the print head a droplet of the liquid. In the following, the opening or the duct is also called a nozzle in the context of the present invention.

According to a preferred embodiment of the ink jet device according to the invention, the inkjet device comprises a multi nozzle print head and filling means for providing each nozzle with a different substance. This allows filling the print head of the ink jet device with preferably all different substances to be printed onto the substrate. For example if a substrate should be provided with 16 different substances, the print head is provided with at least 16 nozzles, whereby at least 16 filling means are provided to source each of the at least 16 nozzles with its own substance.

In a particularly preferred ink jet device according to the invention, the ink jet device is provided with means to position the multi nozzle print head such that it can make an angle with the direction of relative movement of the print head to the substrate, i.e. the printing direction. This embodiment enables to produce about any desired pattern of deposited substances onto the substrate. Indeed by changing the angle of the print head relative to the print direction, a different pattern may be obtained easily. In this embodiment the total number of possible depositions per substance is limited by the nozzle count per print head only.

In an even more preferred embodiment of the ink jet device according to the present invention the substrate is positionable to make an angle with the direction of relative movement of the print head to the substrate. This offers the possibility to produce even more patterns of deposited substances onto the substrate. It is even possible to provide different patterns for different areas of the substrate by changing the angle of the substrate before, during or after a print head move has been performed.

A further preferred embodiment of the ink jet device according to the present invention comprises a plurality of print heads and filling means for providing each print head with its own substance. This embodiment has the additional advantage that in order to change one of the substances to produce a different pattern of depositions it is only required to replace the print head and/or filling means containing the old substance with a print head and/or filling means containing the novel substance. This adds flexibility to the printing process and moreover allows performing operations off line, such as cleaning for instance.

A particularly preferred embodiment of the ink jet device comprises print heads which are positioned one after the other in the direction of relative movement of the print heads to the substrate, i.e. in the print direction. This allows providing the ink jet device with a carrier, wherein the print heads can be mounted in the desired order. In this way it becomes possible to provide the ink jet device with an integrated multi nozzle print head, which is composed according to the pattern to be produced.

Even more preferred is an ink jet device, wherein the print heads in the direction perpendicular to the direction of relative movement of the print heads to the substrate, are aligned such that each nozzle of the print heads provided with its own substance is, in the direction of movement, aligned with the substrate location where its droplet(s) is/are to be positioned on the substrate. In this way it becomes possible to deposit each substance by its own print head only, which obviates the need for frequent cleaning and moreover reduces the risk for misprints and other errors and increases the production speed.

Another preferred embodiment of the ink jet device of the present invention is characterized in that it comprises a plurality of print heads and filling means for providing each print head with its own substance, wherein the print heads are positioned one after the other in the direction of relative movement of the print heads to the substrate, and wherein the print heads each comprise a plurality of nozzles. Thereby, it is possible to eject a plurality of droplets out of one single print head. In this embodiment it is not necessary to drive all nozzles of the multi nozzle print heads. With print heads containing one substance, preferably all nozzles are filled with the substance. It is also possible to be able to fill only a selected number of nozzles, but then the hardware of the print head should be adapted, which is not the preferred solution. With all nozzles filled with substance, it is possible to drive each nozzle separately by individual nozzle timing. In this way, only droplets are jetted out of the nozzles which are driven. Rather those nozzles are preferably fired or driven which, in the direction of movement, are aligned with the substrate location where its droplet is to be positioned on the substrate. This embodiment has the additional advantage that when a different pattern of depositions is required, it is only necessary to change the driven nozzles. When more depositions are required, additional multi nozzle print heads may be provided. In most cases the pitch of the pattern of the depositions in the multi nozzle print head is selected to be equal to the desired pitch of the nozzles. To adapt the pitch of the multi nozzle print head to the desired pitch, it is also possible to provide the ink jet device with positioning means, which enable to rotate the multi nozzle print head or heads with respect to the print direction. In this way, all possible pitches smaller than the pitch of the print head can be obtained. By using every second nozzle only (or third, or fourth, or any other number, depending on the desired size of the pitch) and by placing the print head with an angle respective to the print direction, also pitches larger than the pitch of the print head can be obtained.

It is much preferred according to the present invention to use an ink jet device where the ink jet device further comprises a print table and a printing bridge, a stage with a substrate carrier in the form of a fixture plate, movably relative to the print table along a first direction and the at least one print head mounted on a movable print head holder being mounted to the printing bridge such that the at least one print head is rotatable relative to the printing bridge to make an angle with the first direction. Thereby it is possible to print or release droplets of a substance to a large area of application such that the production of printed products can be made quite cost effective because large substrates or individual substrates can be printed as one batch. In this embodiment a tray with different substrates may be printed all at once. The print table moves in one direction, the print head holder in the other direction. In some cases, the print table can also move in both directions. By doing so, the whole tray with substrates can be provided with all substances. The required production time is usually limited by batch size. Relatively speaking, the smaller the batch size, the larger the amount of time will be for aligning, cleaning, filling, and performing other operations of the nozzles.

Even more preferred is to provide an ink jet device, wherein the printing bridge is fixed relative to the print table, and wherein the substrate carrier is movable relative to the printing bridge in the first direction, wherein the print head holder is rotatable relative to the printing bridge to make an angle with the first direction. By making the substrate carrier movable and keeping the at least one print head in a fixed position a very high production rate may be achieved. Several means to make the substrate carrier movable relative to the print table may be envisaged. A preferred option to enable moving the printable substrates relative to the at least one print head is to provide the ink jet device of the invention with substantially continuous moving means, such as for instance an endless conveyor belt. With a continuous line production (endless conveyor belt), the substrates move underneath the print head(s), whereas the print head(s) do not move. This results in a much higher production rate. Other options may however be envisaged by the skilled person.

A further preferred embodiment of the ink jet device according to the present invention is characterized in that the fixture plate is rotatable relative to the printing bridge to make an angle φ with the first direction. This allows producing substrates with more elaborate deposition patterns. In this respect it is even more preferred to provide the ink jet device with a print head holder which is movable relative to the printing bridge in a second direction, which first and second direction are most preferably mutually orthogonal.

According to the present invention, it is preferred that the substrate is a flat substrate, a structured substrate or a porous substrate. More preferably, the substrate is a nylon membrane, nitrocellulose, or PVDF substrate, or a coated porous substrate. Because the substrate is preferably porous, the spots or the droplets do not only lie on the surface, but also penetrate into the membrane.

In still a further embodiment of the present invention, the substrate comprises a plurality of substrate areas, each substrate area preferably being a separated membrane held by a membrane holder. Thereby, a plurality of separated membranes may be produced at high production speeds by the use of the inventive ink jet device.

The present invention is not limited to any particular printable substances. Preferably however, the printable substances comprise a volatile solution in liquids like water and the like where different molecules or different compounds, especially bio-molecules are present. Different additives can be added to improve the droplet and spot formation characteristics, e.g. alcohols such as glycerol, detergents and the like.

The present invention also includes a method for producing a biological assay substrate by releasing a plurality of substances onto the substrate, using an ink jet device as described above, which ink jet device comprises at least one print head, which is positionable relative to the substrate, and which comprises at least one nozzle, provided to eject a droplet, wherein the plurality of substances are deposited onto the substrate in a predefined pattern in about one move of the at least one print head relative to the substrate. The advantages of the method are apparent from and have already been described in the context of the description of the ink jet device and consequently will not be repeated here.

A particularly preferred method is characterized in that the inkjet device comprises a multi nozzle print head and filling means for providing each nozzle with a different substance, wherein the filled multi nozzle print head and/or the substrate are moved relative to each other, whereby the nozzle print head is positioned to make an angle with the direction of relative movement of the print head to the substrate, and the print head releases its substances to produce the predefined pattern.

An even more preferred method uses an inkjet device which comprises a plurality of print heads and filling means for providing each print head with its own substance, wherein the filled print heads and/or the substrate are moved relative to each other, whereby the print heads are positioned one after the other in the direction of relative movement of the print heads to the substrate, and whereby the print heads in the direction perpendicular to the direction of relative movement of the print heads to the substrate, are aligned such that each nozzle of the print heads is, in the direction of movement, aligned with the substrate location where its droplet is to be positioned on the substrate, and the print heads release their substances to produce the predefined pattern.

A further preferred embodiment of the method according to the present invention makes use of an ink jet device, wherein the print heads each comprise a plurality of nozzles, of which at least some are driven to jet droplets. In an even more preferred method the substrate is positioned to make an angle with the direction of relative movement of the print head to the substrate.

The present invention also includes the use of an inventive ink jet device according to the present invention, wherein the substance comprises a biochemical reactant and/or a nucleic acid and/or a polypeptide and/or a protein and/or a cell. By using the inventive ink jet device for such a purpose, it is possible to very accurately print a substantial number of substances onto a substrate, which may include a substantial amount of membranes, substantially without an error, and at a relatively high production speed.

The present invention also relates to an assay substrate comprising a plurality of substances for biological analysis, which substrate may be obtained by the ink jet device and method of the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings, wherein:

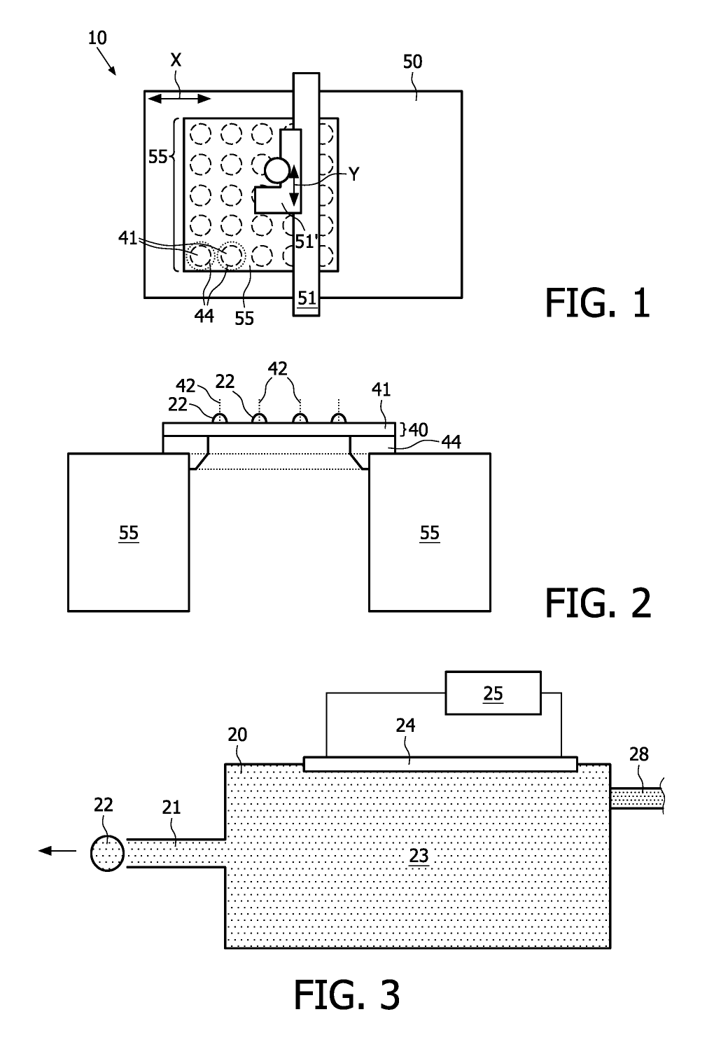

FIG. 1 illustrates schematically a top view of an embodiment of the ink jet device of the present invention;

FIG. 2 illustrates schematically a cross section through a substrate area and a membrane holder;

FIG. 3 illustrates schematically a print head with a nozzle and a detection means;

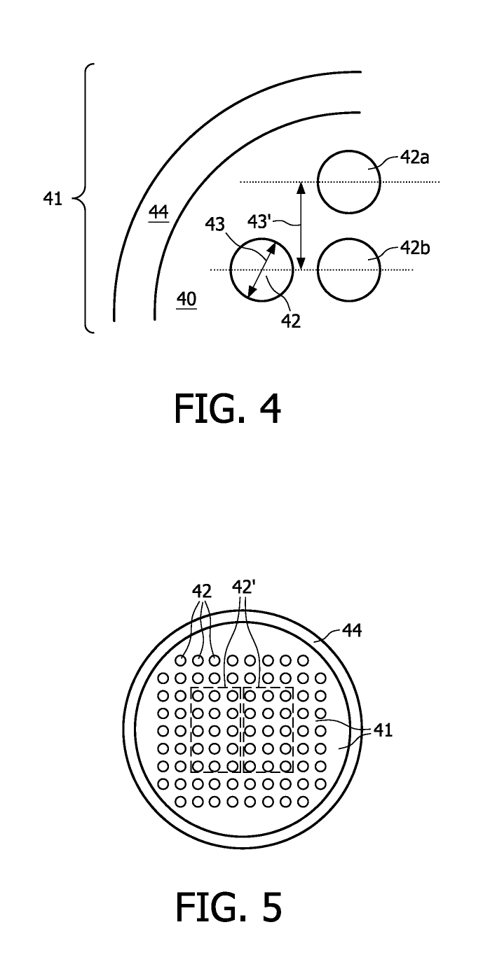

FIG. 4 illustrates schematically a part of a substrate area together with a membrane holder;

FIG. 5 illustrates schematically a complete membrane with membrane holder;

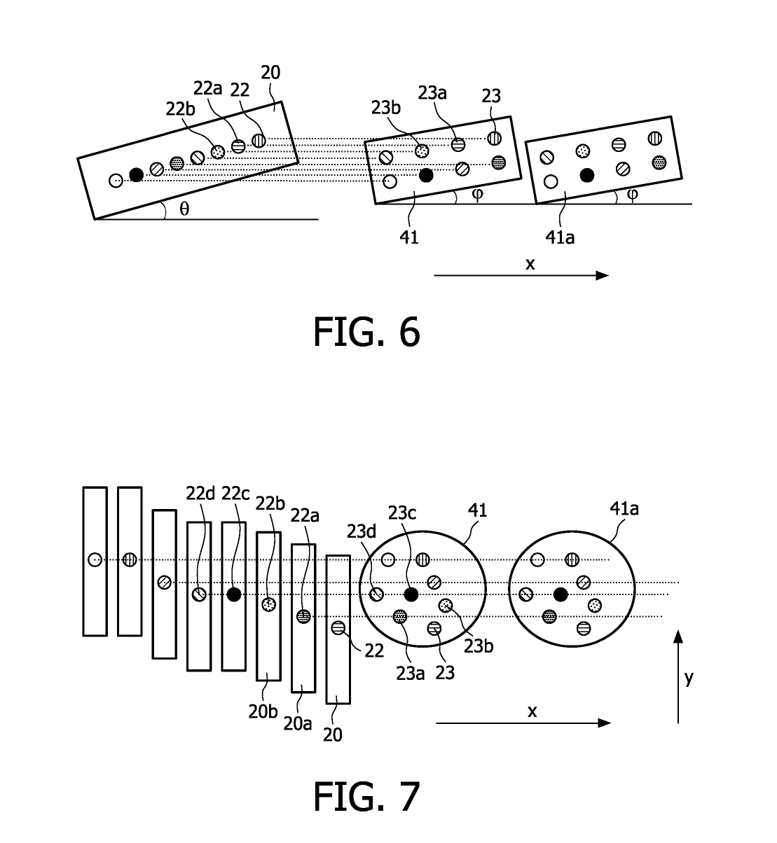

FIG. 6 illustrates schematically a top view of a multi-nozzle linear array print head and substrates according to the invention;

FIG. 7 illustrates schematically a top view of a plurality of single-nozzle print heads and substrates according to the invention;

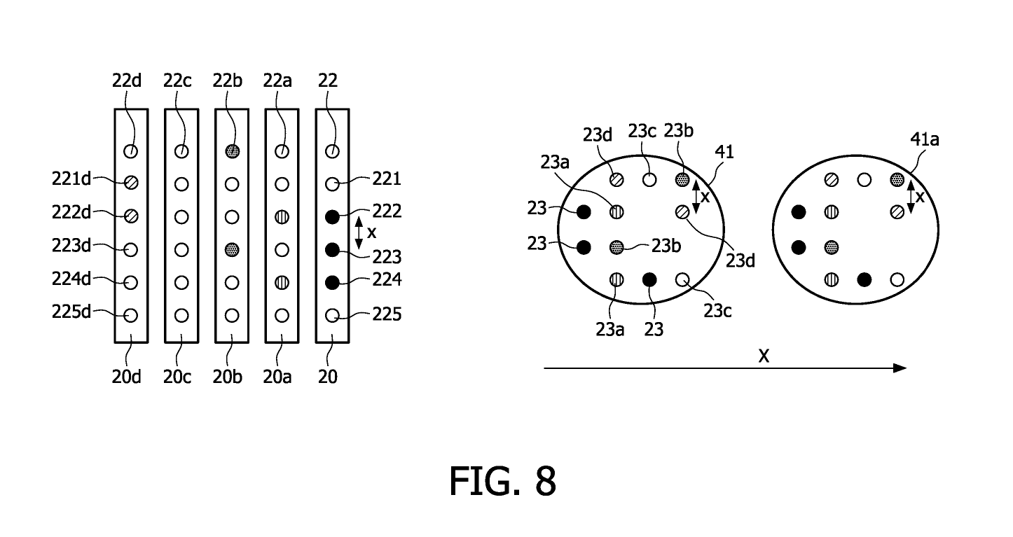

FIG. 8 finally schematically illustrates a top view of a plurality of multi-nozzle linear array print heads and substrates according to the invention.

In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a schematic top view of the ink jet device 10 according to the present invention is shown. On a print table 50 a fixture plate 55 is mounted on a linear stage allowing for motions in the X direction of the fixture plate 55. In preferred embodiments according to the invention fixture plate 55 is also rotatable over an angle φ with respect to the X-direction (see for instance FIG. 6). In this fixture plate 55, a number of membrane holders 44 with membranes 41 are positioned. The totality of membranes 41 are referred to as the substrate 40. The membrane holder 44 may have any form, for instance rectangular as shown in FIG. 6, but is preferably a ring 44. A round membrane 41 is welded onto this ring. So, after printing, the ring 44 with spotted membrane 41 together constitutes the final product. A printing bridge 51 is rigidly mounted relative to the print table 50. The printing bridge 51 carries the movable print head holder 51′. The stage with the fixture plate 55 is moveable along a first direction, the X-direction. A print head 20 is mounted to the print head holder 51′, which is preferably movable along a second direction, the Y-direction, relative to the printing bridge 51. In preferred embodiments according to the invention print head holder 51′ is also rotatable over an angle θ with respect to the X-direction (see for instance FIG. 6). According to the present invention, it is preferred, that the first direction (X-direction) and the second direction (Y-direction) are orthogonal. Thereby, the print head 20 can be moved over a certain area of a print table 50 and can release droplets of a substance, which is stored in the print head 20 or in a reservoir (see FIG. 7) near the print head 20. The membranes 41 are mounted in the fixture plate 55, also called registration plate 55 at uniform distance in X-direction and uniform distance in Y-direction. The distance in X-direction may differ from the distance in Y-direction.

The substrate 40 may be made of a bio active membrane used for the detection of infectious diseases. Diagnostics of such diseases demands for a very high reliability of the printing process. The read out of the fluorescent pattern relates diseases directly to the positions of the specific capture probes. Therefore, it is absolutely necessary to have a very reliable process for the printing of the correct substance out of a plurality of different substances. Since many capture probes have to be printed on many substrates, the printing process should be able to produce many substrates in a short amount of time. The ink jet device and method according to the invention provide such a process.

The print table 50 is preferably provided in the form of a granite table. Alternatively, another very heavy material can also be used. According to the present invention, the print table 50 is preferably arranged in an environment, which has very little vibrational disturbances. A precision linear stage is mounted relative to the granite table (print table 50) and a fixture plate 55 mounted on the stage moves by definition in the first direction (X-direction). Another precision linear stage is mounted on the bridge 51 and guides the print head holder 51′ by definition in the second direction (Y-direction).

In FIG. 2, a schematic representation of a cross sectional view of an individual substrate membrane holder 44 and a part of the fixture plate 55 is shown. The membrane holder 44 carries one membrane 41. All membranes 41 together form substrate 40 (in FIG. 2, an accolade has been used to indicate this). One membrane 41 may also be called a substrate area 41. Each individual membrane holder 44 is located on the fixture plate 55 fixedly mounted on a linear stage allowing for a linear motion in the X-direction relative to the granite table (print table) 50. On the substrate 40, i.e. on each membrane 41, a plurality of substrate locations 42 are provided such that an individual dot (schematically shown by reference sign 22 in FIG. 2) is able to be located at a distance from one another. A dot can be formed out of one droplet dispensed by the print head or is built-up out of a plurality of droplets of the same substance. Thereby, it is possible to dispense or to position a different kind of substance on each of the substrate locations 42.

In FIG. 3, a print head 20 with a nozzle 21 25 is schematically shown. The print head 20 comprises a transducer 24. The transducer 24 is preferably a piezoelectric transducer 24. Generally, an electromechanical transducer 24 being able to provide mechanical waves inside the print head 20 can be used as a transducer 24. The transducer 24 can be actuated by an activation pulse (not shown) provided by a control unit (not shown). The print head 20 may be provided with a detection unit 25 or detection means 25, which detects the behaviour of the transducer 24, which is in turn influenced, by the behaviour of the print head 20 and/or the print head 20 together with the fluid or the substance 23 inside the print head 20. Such detection may be helpful as a source of information about the course of the printing process. Print head 20 is further provided with a further duct or throttle 28, through which substance 23 can be supplied.

According to the present invention, a plurality of substances 23 can be provided inside of the print head 20. This is for example done by means of a further duct 60 (not shown) of the print head 20 where a vacuum pump (not shown) can be connected. If the print head is moved such that the nozzle 21 held inside a reservoir 61 of a substance 23 and the vacuum pump is actuated, the substance 23 can be sucked in into the print head 20. To print the substance 23 transducer 24 is actuated by an actuation pulse such that a droplet 22 is ejected from the nozzle 21 of the print head 20.

In FIG. 4, a part of a membrane 41 or a substrate area 41 is shown from the top. On the substrate area 41 are defined a plurality of substrate locations 42, 42a, 42b. The substrate locations 42, 42a, 42b are the locations, where the droplets 22 are to be positioned by the ink jet device 10 according to the present invention. Is it also possible to place a plurality of droplets of the same substance on one single substrate location 42. The droplets 22 which have been ejected by the print head 20 and landed on the substrate 40 will cover a certain dot area or spot around the substrate locations 42, 42a, 42b with an average diameter 43 which is lower than the respective distance 43′ (or pitch) of the substrate locations 42, 42a, 42b from one another. On a substrate area 41, for example 130 spots or substrate locations 42 can be provided where droplets 22 can be printed, each droplet needing a volume of, e.g., around 1 nl. The diameter 43 of the spots or the droplets 22 is for example 200 μm and they are placed in a pattern with a pitch of, e.g., 400 μm. Of course, it is also possible to provide more (up to 1000) and smaller spots necessitating only a smaller pitch of, for example, 300 μm or only 200 μm, 100 μm or 10 μm. The 130 spots are printed for example with one single print head 20 in case all substances 23 are contained in a single print head. In case of a print head for each substance, the 130 spots are printed with a total number of print heads of at least the number of substances. For example, on the fixture plate 55, 140 pieces of membrane holders 44 are arranged which are processed in one batch of printing by the ink jet device 20. The pitch 43′ of the droplet spots is provided in the range of 10 to 500 μm according to the present invention. The diameter 43 of the spots of the droplets 22 is in the range of about 20% to 70% of the actual pitch 43′. The volume of the droplets 22 has to be adapted to the preferred size of the spot and to the material of the substrate 40 used (e.g. dependent of where the substrate strongly or weakly absorbs the substance applied). Typically, the volume of the droplets 22 is about 0.001 nl to 10 nl. It is also possible according to the invention to deposit a number of substances on the same spot location in subsequent passages of the print head(s) over the substrate.

In FIG. 5 a top view of a substrate area 41 obtainable by the ink jet device and method of the present invention is shown. In the embodiment shown, a plurality of substrate locations 42 are represented by small circles. It is possible although not necessary to position many different substances on these different substrate locations 42 in order to use the membrane of the substrate area 41 for diagnostic purposes. Likewise it is possible to define several groups 42′ of substrate locations 42 in order to perform a complete set of tests within one group 42′ of substrate locations 42 and their respective substances.

In FIG. 6 a first embodiment of the ink jet device 10 of the present invention is schematically and partly shown (only print head 20 and substrates 41 are shown). The preferred inkjet device 10 comprises a linear array print head 20 with a plurality of nozzles (22, 22a, 22b, . . . ) and filling means (not shown) for providing each nozzle (22, 22a, 22b, . . . ) with a different substance (23, 23a, 23b, . . . ). Besides linear array print heads, other types of print head may also be used, such as for instance stacked linear array print heads. Print head 20 is filled with all different substances (23, 23a, 23b, . . . ) to be printed onto the substrates (41, 41a). In FIG. 6 eight different substances (23, 23a, 23b, . . . ) are shown. The print head 20 is thus provided with at least 8 nozzles, whereby at least 8 filling means are provided to source each of the at least 8 nozzles with its own substance. Although in the figures only two substrates 41 are shown, it should be clear that many substrates 41 may be printed in one move of the print bridge 51 and/or fixture plate 55. The ink jet device 10 is further provided with means to position the multi nozzle print head 20 such that it can make an angle θ with the direction of relative movement of the print head 20 to the substrates 41, i.e. the printing direction, which in most cases will correspond with the X-direction. As shown in FIG. 6, substrates (41, 41a) are positionable to make an angle φ with the printing direction. By changing the angles θ and/or φ many different patterns of deposited substances (23, 23a, 23b, . . . ) onto the substrates (41, 41a) may be obtained easily.

FIG. 7 relates to a further preferred embodiment of the ink jet device 10. In this embodiment, a plurality of single nozzle print heads (20, 20a, 20b, . . . ) and filling means (not shown) for providing each print head with its own substance are provided. Print heads (20, 20a, 20b, . . . ) are positioned one after the other in the direction of relative movement of the print heads (20, 20a, 20b, . . . ) to the substrates (41, 41a), i.e. in the X-direction. The print heads (20, 20a, 20b, . . . ) are preferably mounted in a carrier (not shown) in the desired order. Print heads (20, 20a, 20b, . . . ) are aligned in the direction perpendicular to the X-direction (denoted as the Y-direction) such that each nozzle (22, 22a, 22b, . . . ) of the print heads, provided with its own respective substance (23, 23a, 23b, . . . ) is aligned with the substrate location where its droplet is to be positioned on the substrates (41, 41a). In FIG. 7, these locations are denoted by (23, 23a, 23b, . . . ) respectively. This alignment between the nozzle position and the projected droplet location is schematically shown by the dotted lines.

FIG. 8 shows another preferred embodiment of the ink jet device 10 of the present invention, wherein is provided a plurality of linear array print heads (20, 20a, 20b, . . . ) and filling means (not shown) for providing each print head (20, 20a, 20b, . . . ) with its own substance ( ). Print heads (20, 20a,20b, . . . ) are positioned one after the other in the X-direction and each comprise a plurality of nozzles (22, 221, 222, . . . , 22a, 221a, 222a, . . . ). As shown in FIG. 8 each print head contains its own substance. Print head 20 contains substance 23, print head 20a contains substance 23a, and so on. Per print head (20, 20a, 20b, . . . ) only the nozzles (22, . . . ) that must fire the corresponding substance (23, . . . ) on the substrate may be driven. Only those nozzles are driven which, in the X-direction are aligned with the substrate location where its droplet is to be positioned on the substrate. For instance in print head 20 only nozzles 222, 223 and 224 are driven. Nozzles 22, 221 and 225 are not driven, or are not connected to the filling means. Likewise in print head 20d, only nozzles 221d and 222d are driven, while nozzles 22d, and 223d to 225d are not driven or not connected to the filling means. Although this is the preferred method to obtain selective firing of nozzles, other methods may be envisaged within the scope of the invention. It is for instance possible to only load nozzles with substance 23 that need to fire, or to load all nozzles with substance 23 and block those nozzles that need not to fire.

1. Ink jet device (10) for releasing a plurality of substances (23, 23a, 23b) onto a substrate (40), the device (10) comprising at least one print head (20), which is positionable relative to the substrate (40), and which comprises at least one nozzle (21), provided to eject a droplet (22), whereby the ink jet device (10) is designed such that the plurality of substances (23, 23a, 23b) can be deposited onto the substrate (40) in a predefined pattern in a limited amount of moves of the at least one print head (20) relative to the substrate (40).

2. Ink jet device according to claim 1 wherein the inkjet device (10) comprises a multi nozzle print head (20) and filling means (100) for providing each nozzle with a different substance (23, 23a, 23b).

3. Ink jet device according to claim 2 wherein the multi nozzle print head (20) is positionable to make an angle with the direction of relative movement of print head (20) to substrate (40).

4. Ink jet device according to claim 2, wherein the substrate (40) is positionable to make an angle with the direction of relative movement of print head (20) to substrate (40).

5. Ink jet device according to claim 1, wherein the ink jet device (10) comprises a plurality of print heads (20, 20a, 20b) and filling means (100) for providing each print head (20, 20a, 20b) with its own substance (23, 23a, 23b).

6. Ink jet device according to claim 5, wherein the print heads (20, 20a, 20b) are positioned one after the other in the direction of relative movement of print heads (20, 20a, 20b) to substrate (40).

7. Ink jet device according to claim 5, wherein the print heads (20, 20a, 20b) in the direction perpendicular to the direction of relative movement of the print heads (20, 20a, 20b) to the substrate (40), are aligned such that each nozzle (21) of the print heads (20, 20a, 20b) provided with its own substance (23, 23a, 23b) is, in the direction of movement, aligned with the substrate location (42, 42a, 42b) where its droplet (22) is to be positioned on the substrate (40).

8. Ink jet device according to claim 5, wherein the print heads (20, 20a, 20b) each comprise a plurality of nozzles (21, 21a, 21b).

9. Ink jet device (10) according to claim 1, wherein the ink jet device (10) further comprises a print table (50) and a printing bridge (51), a stage with substrate carrier (55) movably relative to the print table (50) along a first direction (X-direction) and the at least one print head (20) mounted on a movable print head holder (51′) being mounted to the printing bridge (51) such that the at least one print head (20) is rotatable relative to the printing bridge (51) to make an angle θ with the first direction.

10. Ink jet device (10) according to claim 9, wherein the printing bridge (51) is fixed relative to the print table (50), and wherein the substrate carrier (55) is movable relative to the printing bridge (51) in the first direction (X-direction), wherein the print head holder (51′) is rotatable relative to the printing bridge (51) to make an angle θ with the first direction.

11. Ink jet device (10) according to claim 9, wherein the substrate carrier (55) is rotatable relative to the printing bridge (51) to make an angle φ with the first direction (X-direction).

12. Ink jet device (10) according to 9, wherein the print head holder (51′) is movable relative to the printing bridge (51) in a second direction (Y-direction).

13. Ink jet device (10) according to claim 10, wherein the first direction (X-direction) and the second direction (Y-direction) are mutually orthogonal.

14. Ink jet device (10) according to claim 1, wherein the substrate (40) is a flat substrate, a structured substrate, a coated substrate or a porous membrane (41), preferably a nylon membrane.

15. Ink jet device (10) according to claim 1, wherein the substrate (40) comprises a plurality of substrate areas (41), each substrate area (41) preferably being a separated membrane (41) held by a membrane holder (44).

16. Method for producing a biological assay substrate (40) by releasing a plurality of substances (23, 23a, 23b) onto the substrate (40), using an ink jet device (10) comprising at least one print head (20), which is positionable relative to the substrate (40), and which comprises at least one nozzle (21), provided to eject a droplet (22), wherein the plurality of substances (23, 23a, 23b) are deposited onto the substrate (40) in a predefined pattern in a limited amount of moves of the at least one print head (20) relative to the substrate (40).

17. Method according to claim 16, wherein the inkjet device (10) comprises a multi nozzle print head (20) and filling means (100) for providing each nozzle with a different substance (23, 23a, 23b), wherein the filled multi nozzle print head (20) and/or the substrate (40) are moved relative to each other, whereby the nozzle print head (20) is positioned to make an angle θ with the direction of relative movement of print head (20) to substrate (40), and the print head (20) releases its substances (23, 23a, 23b) to produce the predefined pattern.

18. Method according to claim 16, wherein the inkjet device (10) comprises a plurality of print heads (20, 20a, 20b) and filling means (100) for providing each print head (20, 20a, 20b) with its own substance (23, 23a, 23b), wherein the filled print heads (20, 20a, 20b) and/or the substrate (40) are moved relative to each other, whereby the print heads (20, 20a, 20b) are positioned one after the other in the direction of relative movement of the print heads (20, 20a, 20b) to the substrate (40), and whereby the print heads (20, 20a, 20b) in the direction perpendicular to the direction of relative movement of the print heads (20, 20a, 20b) to the substrate (40), are aligned such that each nozzle (21) of the print heads (20, 20a, 20b) is, in the direction of movement, aligned with the substrate location (42, 42a, 42b) where its droplet (22) is to be positioned on the substrate (40), and the print heads (20, 20a, 20b) release their substances (23, 23a, 23b) to produce the predefined pattern.

19. Method according to claim 18, wherein the print heads (20, 20a, 20b) each comprise a plurality of nozzles (21, 21a, 21b), of which at least some are provided with a substance (23, 23a, 23b).

20. Method according to claim 16, wherein the substrate (40) is positioned to make an angle φ with the direction of relative movement of print head (20) to substrate (40).

21. Use of an ink jet device (10) according to claim 1, wherein the substances (23) comprise a biochemical reactant and/or a nucleic acid and/or a polypeptide and/or a protein.

22. Assay substrate comprising a plurality of substances for biological analysis, obtainable by the method according to claim 16.
